(19) United States
(12) Patent Application Publication
(10) Pub. No.: US 2006/0146462 A1
(43) Pub. Date: Jul. 6, 2006

(54) Enhanced safety stop device for pools and spas

(75) Inventor: Arthur J. McMillian IV, Austin, TX (US)

Correspondence Address: PEI Michael Perkins, 902 McPhaul St, Austin, TX, 78758-4808, US

(73) Assignee: Andy Hines, Austin, TX (US)

(21) Appl. No.: 11/324,420

(22) Filed: Jan. 3, 2006

Related U.S. Application Data
(60) Provisional application No. 60/646,031, filed on Jan. 4, 2005.
(60) Provisional application No. 60/732,933, filed on Oct. 31, 2005.

(51) Int. Cl. H02H 3/00

(52) U.S. Cl. 361/62

(57) ABSTRACT

An emergency device for safely shutting off pumps and associated equipment (loads) for pools and spas. The emergency input device is mounted within code required distance of the pools or spas and electrically connected to switch box by radio signals. The switch box features relays that will interrupt power to motor and associated equipment when signaled by emergency input device. Switch box features a reset with automatic, remote radio, and manual capability that re-energizes the motor and equipment when an emergency is cleared. The separation of the emergency input device and reset switch removes the possibility of resetting false signals. A discreetly mounted remote reset switch affords operators additional emergency reaction choices. The switch box additionally provides an alarm and a remote monitoring capability for supervisory personal. The circuit design of emergency device protects motor and equipment from transients and early failure with orderly shut down. Modular design of emergency device allows simple single applications or scaling up for additional motors and equipment.

### FEDERALLY SPONSORED RESEARCH

Not Applicable

### SEQUENCE LISTING OR PROGRAM

Not Applicable

### BACKGROUND

1. Technical Field of Invention

This invention relates to safety and enhanced remote control of power loads or equipment.

2. Background of the Invention

Existing commercial pools and spas control hazards have been largely un-addressed by manufacturers and operators. The majority of commercial installations are unattended and without monitoring. Following customer deaths and recent legislation a safety device must be available to reduce hazard and injuries. In U.S. Pat. No. 5,920,923 Jillette discloses a hydro-therapeutic stimulator for females and includes control for user. Jillette intended a specialized clientele and individual control is all that is offered which will not satisfy the requirements of large or commercial pools or spas. In U.S. Pat. No. 6,109,050, Zakryk discloses a “Self regulating pool heater unit” with an automatic timer by-pass switch. Although Zakryk includes “safety monitoring” facilities (for conditioning equipment) there is nothing to offer ease of identify, immediately available emergency safety shut off capability for user hazards. In U.S. Pat. No. 6,552,284 Drago discloses a water pump low-pressure cutoff switch. While this is a potentially a useful device it affords no offering of immediately available emergency safety shut off capability. In U.S. Pat. No. 6,747,367 Cline discloses a controller system for pool and/or spa. While Cline has a comprehensive controller proposed the extensive functionality and operator focus of the controller are prohibitive for an immediately available emergency safety identification and shut off. In U.S. Pat. No. 6,775,863 Hutchings discloses a spa or pool switch that can be used on a pool or spa shell without drilling a hole in the shell. While Hutchings has a potentially useful device it is designed for user control and not suited for general applications and pre-installed systems requiring an immediately available emergency safety shut off capability. A vacuum monitoring cutoff device is offered by Stingl (no patent evident). The Stingl Switch monitors vacuum levels and will cutoff power through a contactor when vacuum level is detected. This device does not comply with Code requirements; no visible switch for individuals and has been plagued with late response and corrosion problems. An emergency cutoff device is offered from Compool. Compool offers a LX80/2 (no patent evident) that will afford an emergency cutoff switch for pools and spas. This offering has many options and flexibility but demands a cable be run to the safety cutoff switch near the pool or spa. This limitation (hard line connection) has unnecessary hazards from water and potential high installation costs around concrete and other associated physical structures during retrofitting of device. Efforts to date have offered control panels that could be confusing or difficult to access in an emergency situation. There exists a need for an immediately available emergency safety shut off capability within sight to satisfy National Electric Code 680-12 (2005). In addition a need exists for simplified installation of potentially complicated and expensive retro installation while maintaining safety aspects for patrons. Also, remote monitoring will improve potential responsiveness by site supervisors in emergency situations. An optional automatic reset will minimize unnecessary down time and maintain water quality of hot tub or pool after an emergency. Furthermore, a remote reset will increase operator flexibility and reduce requirements on site staff.

### OBJECTS AND ADVANTAGES

Objects

Accordingly, besides the objects and advantages of the devices described in my above patent, several objects and advantages of the present invention are:
a. to provide a device capable of immediately halting operation of all pumps and associated equipment (loads),
b. to provide a reset that is separate from shut down switch to avoid misuse,
c. to provide an orderly shut down of loads that is electrically safe (reduced arcing),
d. to provide a positive halt switch to remove operator confusion (as with multifunction panels) or indecision,
e. to provide a device that can be expanded to include multiple loads,
f. to provide a device that can be easily installed,
g. to provide a radio remote off to simplify device installation, for security purposes a remote radio cutoff that changes codes each time used to prevent hi-tech monitoring and capture. And only responds to programmed pair
h. to provide a radio remote reset to simplify system reset, for security purposes a remote radio reset changes codes each time used to prevent hi-tech monitoring and capture. Uses 4.3 billion different access security codes. And only responds to programmed pair
i. to provide a radio remote alert to notify responsible individual,
j. to provide a self contained auto reset function with a delay time to allow for emergency to be cleared.
k. accomplish embodiment with FCC certified enabling wireless controllers for low production volumes,
l. accomplish embodiment with discrete wireless components for high production volumes.
   Advantages

As can be seen in the following drawings advantages include a simple device and enclosure including ease of installation for ease of retrofitting on existing pools and spas. Purposed being to provide for the orderly shutdown of power to pumps, motors, and associated equipment (loads) with minimal arcing for load protection and increased reliability. Orderly is defined herein as systematic removal of electrical current and voltage through relay contactors to minimize shock to loads such as pumps and motors that can be damaged by arcing as a result of direct disconnection.

Further objects and advantages are to provide a small efficient device that can easily fit in cramped spaces and handle all necessary current of expected device loads. Additionally, to simplify installation by connecting remote switch by radio waves over a transmitter/receiver pair with battery power to eliminate effort intensive cable installation. In addition to simplify operation by connecting a remote reset switch by radio waves with battery power to eliminate the need for operators to access pump house equipment when restarting pump and heater after a shut down. Additionally, to provide a monitoring capability to notify responsible individual when a shut down has been initiated. In addition to provide an automatic restart function that can be selectively engaged and when engaged restart anytime a shut down is performed.

### SUMMARY OF THE INVENTION

In accordance with the present invention a Safety Stop device includes a circuit board that can be modularly adapted and configured to most requirements by a technician on site. The present statute follows for readers information.

IV. Spas and Hot Tubs

From National Electric Code (NEC) 2005 the following:

680.40 General.

Electrical installations at spas and hot tubs shall comply with the provisions of Part I and Part IV of this article.

680.41 Emergency Switch for Spas and Hot Tubs.

A clearly labeled emergency shutoff or control switch for the purpose of stopping the motor(s) that provide power to the recirculation system and jet

system shall be installed at a point readily accessible to the users and not

less than 1.5 m (5 ft) away, adjacent to, and within sight of the spa or hot.

tub. This requirement shall not apply to single-family dwellings.

The difficulty involved in installation of the Safety Stop device comes from existing structures around Hot Tubs and the nature of having water and splashing around electrical distribution devices. To address these difficulties the Safety Stop device has a battery powered radio transmitter for the cutoff switch mounted near the Hot Tub as required by National Electric Code. The switch is housed in a sealed and gasketed enclosure. The radio uses a pre-operational programmed transmitter/receiver pair that features 4.3 million unique combinations for a secure rolling code to prevent “mistaken” cutouts from other transmitters on the same frequency or nearby frequency bleeding over. Additionally, a remote reset is also available for operators not wanting to go into pool house to reset Hot Tub power after a cutoff or power failure. The minimal night staffing of places such as Motels demands that managers not be away from front desk for extended periods. The reset switch is not labeled and placed under the box to avoid casual use by the curious or pranksters. The reset switch features an identical but separately programmed transmitter/receiver pair. Furthermore, a remote alert is included with Safety Stop to alert management staff that may be remote from the Hot Tub with Safety Stop. This audible alarm consists of a sonnelert that will be energized by operation of cutoff switch. The audible alarm is detected by a microphone and radio that transmits the audible signal of the sonelert to a receiver located near management (such as a front desk clerk in a Motel or Hotel). When the signal from the remote monitor speaker is heard the clerk follows individual management procedures to effect safety measures and after the emergency is cleared restores Hot Tub to normal operation with reset switch located with the cutoff switch or at the pump equipment station. Additionally, an automatic reset feature may be enabled. This feature is enabled where management is convinced that no safety problems will be encountered when the cutoff will reset automatically, typically 15 minutes after cutoff switch is activated. The adaptation of enabling wireless controllers reduces the cost impact in a cost sensitive market of FCC certification for low power radiating devices in control bands. Larger volumes would use discrete components and amortize development and certification costs over more units.

### BRIEF DESCRIPTION OF THE DRAWINGS

FIG. 1 is a perspective view of my Safety Stop for Pools and Spas installed on a spa.

FIG. 2 is a perspective view of Safety Stop for Pools and Spas control enclosure.

FIG. 3 is a wiring block diagram for radio control portion of Safety Stop for Pools and Spas.

FIG. 3A is a wiring diagram for circuit modifications to cutoff and reset radio transmitters.

FIG. 3B is a wiring diagram for circuit modifications to cutoff radio receiver.

FIG. 4 is a schematic wiring diagram for switching control portion of Safety Stop for Pools and Spas.

FIG. 5 is a schematic wiring diagram for output control portion of Safety Stop for Pools and Spas.

FIG. 6 is a schematic wiring diagram for auto reset timer and remote monitor portion of Safety Stop for Pools and Spas.

FIG. 6A shows details of remote monitoring components.

Details of sources: Nunn electric 622 Morrow st. Austin, Tex. 78752 Johnstone Supply 3007 Longhorn Blvd. Austin, Tex. 78758 Fox Electric Supply 3901 G st. Philadelphia, Pa. 19124

Intellicode™ is a trademark of Genie® company.

Genie® is a registered trademark of The Genie® company.

### DETAILED DESCRIPTION OF THE INVENTION

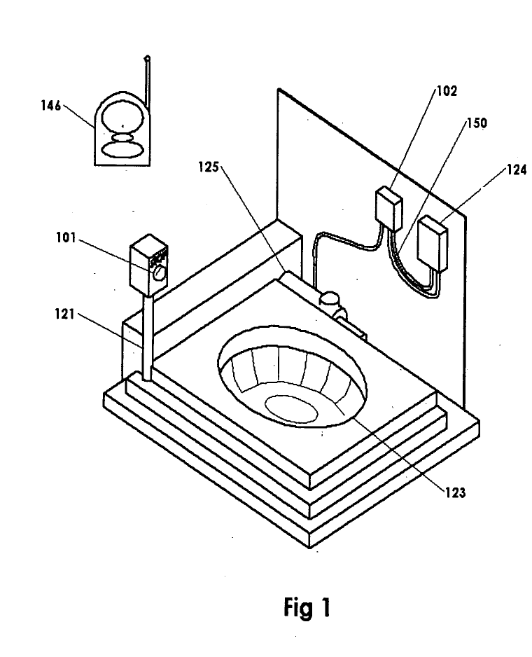

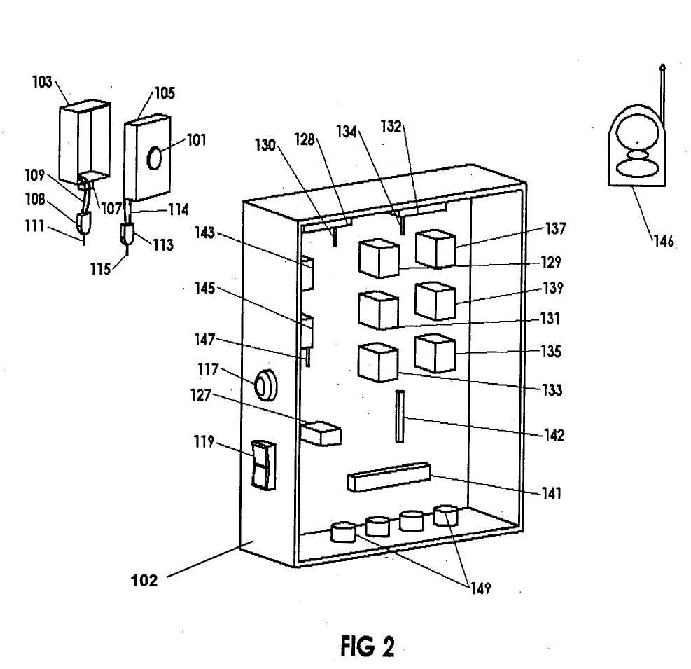

A preferred embodiment of the Enhanced Safety Stop for Pools and Spas is illustrated in FIG. 1. A spa 123 is shown with an emergency cutout switch 101 mounted on a rail post 121. The switch 101 is mounted with easy view and access of all persons in the area of the spa. By placing switch 101 near the pool or spa should an emergency occur (e.g. a person held against a drain with suction) anyone nearby could disable the pump creating the suction by pressing switch 101. The switch 101 is connected by a radio transmitter (shown in FIG. 2), and enabling wireless controller to a switch box enclosure 102. The enclosure 102 is also connected to a system line voltage over a cable 150 connected to a site fuse panel 124. A variety of configurations can be set up depending on the requirements of the host system. A typical commercial installation of pumps and valves 125 is shown. When additional loads are to be accommodated multiple enclosure 102 boxes of 3 loads each can be easily configured. A remote monitor 146 is shown in the upper left of FIG. 1. This would typically be placed up to 100 meters away at front desk of a motel where management personal could monitor if a shutoff was initiated.

An additional view inside enclosure 102 is shown in FIG. 2 for a high level description of the circuitry that comprises my Safety Stop for Pools and Spas. The enclosure 102 is a PVC junction box such as E789R from Nunn electric, Austin, Tex. Components on enclosure 102 are Reset switch 117 such as ABW-110-BGR, DPST from Allied Electronics. A by-pass switch 119 SPST from DigiKey is shown for by-pass selection of auto timer reset for the. Multiple penetrations 149 are shown at the bottom of enclosure 102 for input and output of power. Inside enclosure 102 is auto reset timer and remote monitor audio enclosure 143. Positioned closely to enclosure 143 is Audio Alert remote transmitter 145 such as B9636 from Fisher-Price. Transmitter 145 listens for a audio signal from enclosure 143 and transmits this signal over antenna 147 to Audio Alert remote receiver 146 such as B9637 receiver from Fisher-Price of East Aurora, N.Y. (sold as pairs with transmitter 145). A transformer 127 such as P-8565 from Allied Electronics converts line voltage from 240 v AC to 24 v AC. A remote reset receiver 128 such as an Intellicode receiver from Genie company of Alliance, Ohio (sold with tranmitter 108 as transmitter/receiver pairs). Receiver 128 receives radio signals on antenna 130 from remote reset transmitter 108 with antenna 111 such as an Intellicode transmitter from Genie company of Alliance, Ohio. Transmitter 108 is mounted inside an enclosure 103 such as 1554KGY, PVC watertight enclosure and connected by a 2 wire cable 109 to reset switch 107 such as FSMRA7J,4P PTH momentary switch from DigiKey. The switch 107 is typically mounted on bottom of enclosure 103 to avoid unnecessary attention, and could be recessed. An additional remote cutoff receiver 132 is also shown with antenna 134 such as an Intellicode receiver from Genie company of Alliance, Ohio. The antenna 134 receives radio signals from remote cutoff transmitter 113 through antenna 115 such as an Intellicode transmitter from Genie company of Alliance, Ohio. The switch 101 is connected by a 2 wire cable 114 to transmitter 113. The switch 101 is mounted to cover plate 105 (part of enclosure 103). The transmitter 113 mounts inside enclosure 103, A contactor relay 129 such as LY2F-AC24 from Omron available from Allied Electronics provides power switching signal for remote reset. A similar contactor relay 131 is shown for power switching signal for remote cutoff. A contactor relay 133 such as T92P11A22-240 from Allied Electronics is shown for power switching from relay 129 and 131 signals. A similar contactor relay 137 is shown for direct control of power circuit 3. Another similar cont actor relay 139 is shown for direct control of power circuit 2.

Additionally, a similar cont actor relay 135 is shown for direct control of power circuit 1. A Barrier terminal 141 such as a ID89206 available from Summit Electrical Supply is provided for terminating incoming and outgoing power. A ground terminal buss 142 such as 10 lug ground strap from Square D corporation provides termination for line, motor, heater, and pump ground signals

The enclosure 102 circuit is to be grounded to host system, all components should be grounded by best electrical practices as specified in NEC and comply with any local codes.

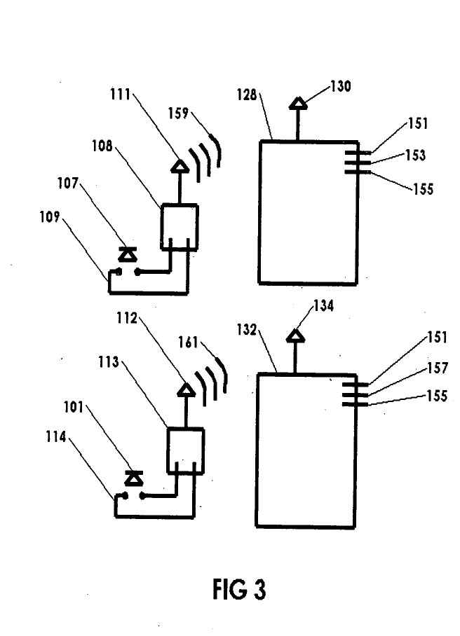

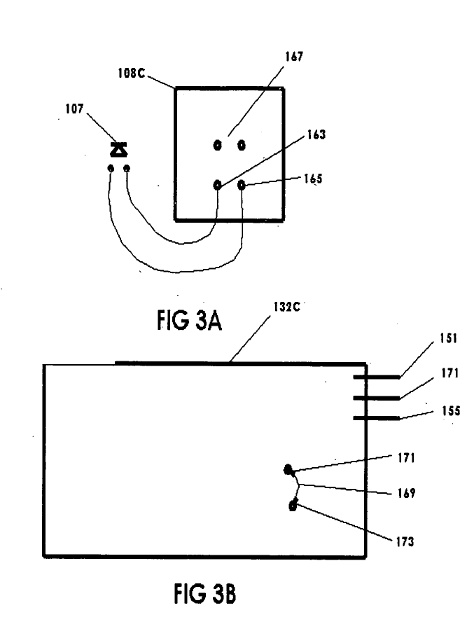

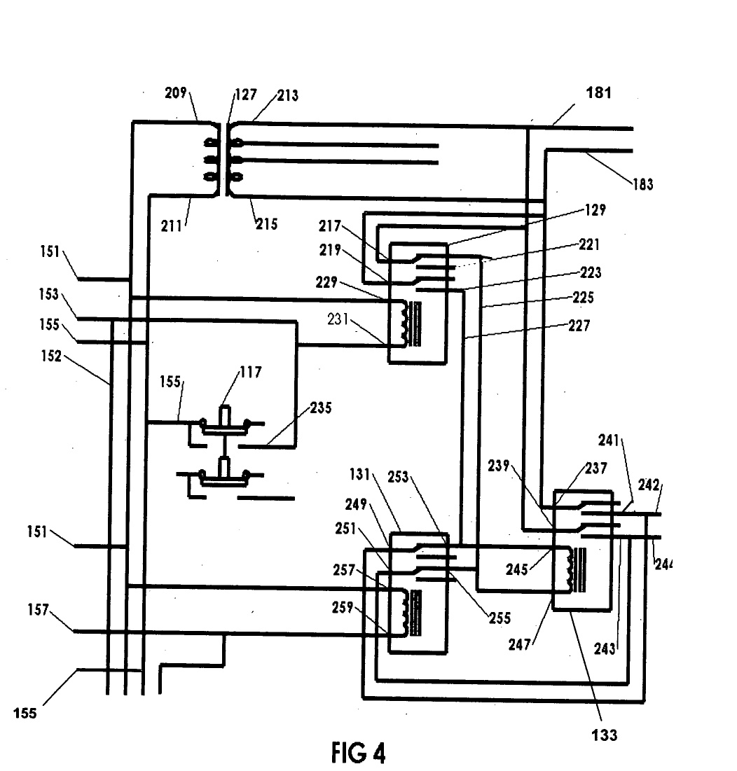

The wiring block diagram of FIG. 3 discloses the radio control components of my Safety Stop for Pools and Spas. The transmitter 108 will send information in a signal 159 (3 curved lines represent the radio signal) over antenna 111 when cable 109 transmits continuity when switch 107 closes contacts. This will typically be when operator desires to restart pump motors after a shutoff event. The signal 159 is received by antenna 130 and sent to receiver 128. The receiver 128 has 24 VAC on line 151 and 24 VAC (neutral) on line 155. A line 153 is has normally open contacts, when signal 159 is received contacts close and voltage is sent to relay 129 (FIG. 4) initiating a restart. Returning to FIG. 3, the transmitter 113 will send information in a signal 161 over antenna 115 when cable 114 transmits continuity when switch 101 closes contacts. This will typically be done when someone identifies a threat or emergency as pool or spa drain. The signal 161 will be received by antenna 134 and sent to a cutoff receiver 132. The receiver 132 has connections to 24 VAC on line 151 and 24 VAC (neutral) on line 155. A line 157 has normally closed contacts and when antenna 134 receives information from transmitter 113 contacts are open to line 157. This action will cause relay 131 (FIG. 4) to drop out. Returning to FIG. 3, receiver 128 and receiver 130 are programmed to respond to only the programmed transmitter. Programming is discussed in operation section of this disclosure. While discrete transmitter/receiver pairs are shown and discussed an encoded multi-bit transmitter/receiver pair with two relays could do the same function. Specifically, with a small controller circuit for transmitter and receiver as discussed in Microchip application sheets; rfPIC12C509AF could substitute for transmitters 113 and 108 (programming rf PIC for multifinction) and a rfRX0920 could substitute for receivers 132 and 128. However, this approach is only valid as it requires FCC certification and the devices (transmitters 113 and 108 with receivers 132 and 128) as disclosed are already certified for retro-fitting as remote controllers.

Modification details of transmitter 108 are shown in FIG. 3A. A circuit board 108C is shown from bottom side with switch 107 connected (soldered) by lines 109 to switch solder point 163 and switch solder point 165. These points are behind switch location point 167 (only switch on component side). These connection points 165 and 163 are parallel to the built in switch and allow remote input and integration of multiple transmitters. The polarity of the connections is unimportant. Modification of transmitter 113 is the same (circuitry is identical) when connecting switch 101 to function remotely.

The modification of receiver 132 is shown in FIG. 3B. The solder side of circuit board 132C of receiver 132 is shown and a jumper 169 connects a point 171 to a point 173. Jumper 169 is soldered to point 171 on solder side of circuit board. The point 173 is directly below output relay, normally open contact on component side of board. The point 171 is the trace connecting line 157 output line. The lines 151 and 155 are unmodified. The receiver 128 is not modified as the reset circuitry utilizes the normally open contacts on line 153. These simple modifications will facilitate mounting of transmitters in an easily identifiable enclosure as required by statute and protect transmitters from weather, elements and mishandling. The receiver modification will allow off the shelf hardware to perform complementary functions with a minimum parts count.

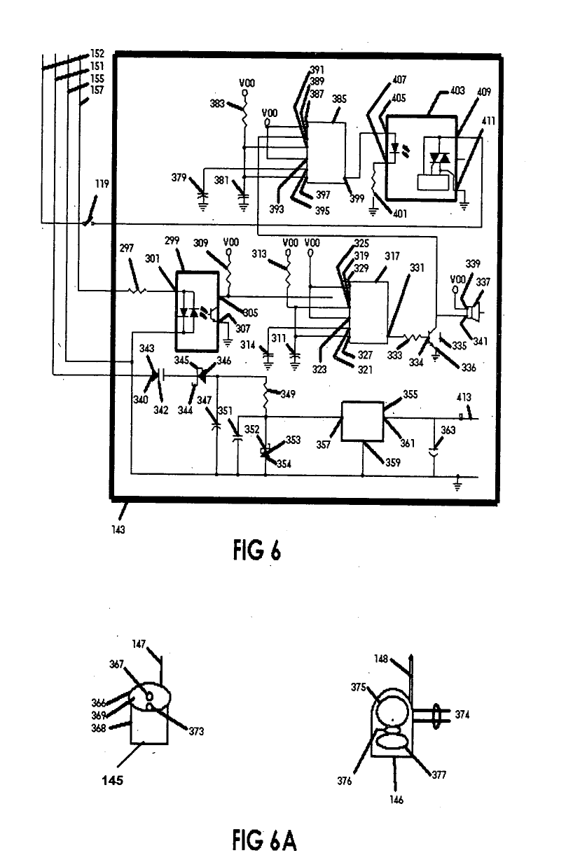

The switching control portion of Enhanced Safety Stop for Pools and Spas is shown in FIG. 4. The transformer 127 is connected to facility power over a line 181 (240 VAC) at a connection point 213 and a line 183 at a connection point 215. The transformer 127 output 24 VAC to line 151 at a point 209 and line 155 at a point 211. The switch 117 has line 155 connected at 156 and line 153 at point 235. This configuration will allow relay 129 which has line 151 connected at point 229 to complete coil enabling at connection point 231 through either direct contact at switch 117 or remotely through line 153 from remote reset at switch 107 (FIG. 2). An additional line 152 is provided for automatic restart. The line 152 originates from timer circuit shown on FIG. 6. Returning to FIG. 4, a short pulse (0.6 sec or greater) is received on line 152 when auto restart is enabled. Incoming power on line 181 connects to input connection 217 on relay 129 and line 183 is connected at input connection 219. The relay 129 has an output 221 that connects to a line 225 and output 223 that connects to a line 227, lines 225 and 227 will energize relay 133 when switch 117 or switch 107 (FIG. 2) are pressed momentarily and power up the system. Returning to FIG. 4, the relay 133 also has connections to relay 131 over line 225 at connection point 255 and line 227 at connection point 253. These connection points 253 and 255 are normally closed and will provide power to relay 133 after initial power up. The relay 133 receives line power over line 181 at connection 239 and from line 183 at connection 237. The input to power relay coils is from line 151 on connection 257 and line 157 at connection 259. The power from relay 131 is tied from output of relay 133. A line 242 is connected to relay 133 at point 241. The line 242 is connected to connection point 249 on relay 131. A line 244 is connected to relay 133 at point 243. The line 244 is connected to connection point 251 on relay 131. The line 225 is connected to relay 133 at connection 247 and line 227 is connected to relay 133 at connection 245. This configuration will allow power up and sustained operation until a signal from switch 101 sends a signal to receiver 132 (FIG. 3), and returning to FIG. 4 voltage is removed from line 157 causing relay 131 to drop out causing relay 133 also to drop out. Thus a remote cutoff is achieved.

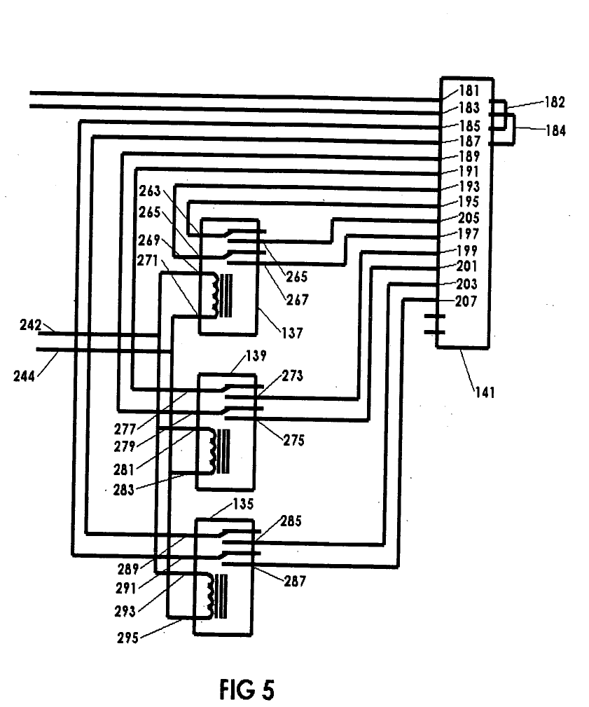

FIG. 5 shows the details of the output control portion of Enhanced Safety Stop for Pools and Spas. The coil portion of output relays 135, 137, and 139 are controlled by signal lines 242 and 244 from relay 133 on FIG. 4. Returning to FIG. 5, the relay 137 connects to line 242 at connection 269 and line 244 connects at connection 271. The relay 139 connects to line 242 at connection 281 and line 244 connects at connection 283. The relay 135 connects to line 242 at connection 293 and line 244 connects at connection 295. These 3 relays 135, 137, and 129 thus have a common signal on lines 242 and 244 and will respond to one signal from switch 101 for remote cutoff. At barrier 141 lines 181 and 185 are tied together by jumper 182 for distribution. Additionally, lines 183 and 187 are also tied together by jumper 184 to facilitate control and distribution of power. The line 185 is connected to relay 135 at connection 291 and line 187 is connected to relay 135 at connection 289. Thusly, power incoming over lines 181 and 183 form external input powers up switching control, output, and is available (for distribution to drive pump or motor from barrier 141) through the normally connected contacts on line 205 over connection 285 and line 207 over connection 287. An input power line 189 connects to relay 139 at connection 279 and a input line 191 at connection 277 for powering a second pump or motor. The power coming into relay 139. over line 189 on normally connected contacts to a line 201 at connection 273 and line 191 on normally connected contacts to a line 203 at connection 275. The power for a second pump or motor is available from lines 201 and 203 at barrier 141. A third power source is provided for by relay 137. The relay 137 receives power over a line 193 on connection 265 and a line 195 on connection 263. This power is available through the normally closed contacts of relay 137 at a connection 265 to a line 197 and at a connection 267 to a line 199. The power for a third motor or pump is available at line 197 and line 199 on barrier 141.

FIG. 6 shows details of the auto reset timer and remote monitor portion of Enhanced Safety Stop for Pools and Spas in enclosure 143. The left portion of FIG. 6 shows the line 152 which supplies reset timer output to FIG. 4. Returning to FIG. 6, a single pole, single throw switch 119 (mounted on enclosure 102, FIG. 2) is provided in line 152 for operating with or without auto reset timer function. Returning to FIG. 6, the line 151 supplies 24 VAC for operation of devices in enclosure 141. The line 155 supplies 24 VAC neutral for operation of devices in enclosure 141. The line 152 supplies signal from an optocoupler 403, such as a Fairchild MOC3033M available from Digikey, output, pin 6 on a connection 409. A output ground is provided for optocoupler 403 at a connection 411. An input for optocoupler 403 anode, pin 1 is provided at a connection 405 and is tied to output of a timer 385 such as a LM555C/TO available from Digikey, on pin 3 at connection 399. A circuit completing ground is provided on optocoupler 403 cathode, pin 2 through a resistor 401 such as a 249Ω ¼ watt at a connection 407. The timer 385 has a VDD supply on pin 8 at a connection 387 and on pin 4 at a connection 393. The timer input trigger is on pin 2 at a connection 389 this line comes from a collector output 338 of a transistor 335 such as a 2N3904. The timer 385 also has pin 5 tied to ground at a connection 395 through a capacitor 379 such as a 0.1 μf 16V, electrolytic. The timer 385 additionally has pin 5 at a connection 391 tied to VDD through a resistor 383 such as a 10KΩ ¼ watt resistor and tied to pin 7 at a connection 397, additionally, this line is tied to ground through a capacitor 301 such as a 47 μf, 25V, values such as these will cause about a 15 minute delay in auto reset pulse typically the pulse output of timer 385 in this configuration will be a pulse of 60 ms in duration output on connection 399 when switch 119 is closed. Such a delay is desirable when initiating a reset to ensure hazard causing cutoff has been cleared. When motor is shutoff suction is relieved at drain and trap freeing potential hazard. If different timing is desired values can be altered to specific application by following application sheets available from manufacturer or at Digikey. If auto reset is not desired switch 119 should be set in the open position. The line 157 is tied through a resistor 297, such as a 1.5 kΩ ¼ W to a connection 301 on pin 1 of an optocoupler 299, such as a PS2705-1 from NEC available from Digikey. The line 155 is tied on pin 2 of optocoupler 299 at a connection 303. This configuration will monitor an emergency cutoff on line 157 and when a cutoff is sensed a signal from optocoupler 299 is transmited through output 4 on a connection 305 to pin 2, at a connection 319, the trigger of a timer 317, such as a LM555C/TO. The connection 305 is also tied to VDD through a 10KΩ ¼ w pull up resistor 309. The optocoupler 299 has an output ground, pin 3, on a connection 307. The timer 317 has additional inputs; an input connection 325 on pin 6, and connection 327 on pin 7 has VDD tied through a 15MΩ ¼ w resistor 313. Additionally, connection 325 is tied to ground through a blocking capacitor 311, such as a 47 μf, 25v tantalum (high frequency requirement).

The timer 317 has input directly from VDD on pin 8 at connection 329 and pin 4 at connection 323. Also, a blocking capacitor 314, such as a 01. μf, 16v ties pin 5 at connection 321. The output of timer 317 on pin 3 has a connection 331 tied through a 240Ω, ¼ w resistor 333. The timer in this configuration will typically produce a 60 second on signal to transistor 335, at connection 334, to transistor 335 base. The transistor 335 has emitter tied to ground at a connection 336. The collector of transistor 335 has output 338 tied to connection 341 on horn 337, such as a Sonalert MSR516NJ, available from Digikey. The opposing side of horn is tied to VDD at a connection 339. The horn 337 in this configuration will typically produce an audible signal with four pules per second, for one minute. A rectifier 343, such as a 1N4001, available from Digikey has line 151 tied to base at connection 340 and emitter at connection 342. The connection 342 is tied to emitter connection of Zener Diode 345 at connection 344. The base of diode 345 at connection 346 is tied to a capacitor 347, such as a 100 μf, 50v available from Digikey, and a resistor 349, such as a 249Ω, ¼ w resistor. The other side of capacitor 347 is tied to line 155. The other side of resistor 349 is tied to a voltage regulator 355 such as a LM7806 available from Digikey at pin 1 through connection 357. Additionally, resistor 349 is tied to a capacitor 351, such as a 100 μf, 50v available from Digikey. The other side of capacitor 351 is tied to line 155. Also, resistor 349 is tied to a zener diode 353, such as a IN4749A, 24v, 1 w at an emitter 352. The diode 353 has base 354 tied to line 155. The regulator 355 has pin 2 tied to line 155 at connection 359. The output of regulator 355 has pin 3 tied to VDD and a line 413 at connection 361. The regulator 355 will typically produce 6 VDC in this configuration. The connection 361 is tied to line 155 through a blocking capacitor 363, typically a 47 μf, 25v capacitor.

The remote monitor function details are shown in FIG. 6A. The remote monitor function consists of a microphone with transmitter 145 and a speaker with receiver 146. The transmitter 145 is typically mounted internal to enclosure 102 (FIG. 2) near enclosure 143. This will allow the horn 337 to be heard by a microphone 367 in transmitter 145. Returning to FIG. 6A an antenna 147 transmits radio frequency signals to corresponding receiver 146 through a receiving antenna 148. The transmitter 145 has an on/off switch 373. A LED 369 provides indication of on status. A 6v power line 366 is to be connected to line 413 shown in FIG. 6. Returning to FIG. 6A a ground line 368 should be connected to line 155 shown in FIG. 6. The receiver 146 receives power from line power over plug 374. An on/off/volume switch 376 is shown for switching power and adjusting volume of received signals on receiver 146. A speaker 377 provides audio signals when received from transmitter 145. A visual display 375 provides a visual cue coupled with audio levels for additional signaling when an emergency has occurred. While specifics are discussed the intent is to provide a Safety Stop device for Pools and Spas. This controller incorporates these features;
Simple installation with reliable radio connections,
Reduced maintenance with sealed containers around batteries and connections, increasing battery reliability,
Improved situational awareness, giving information to remote operators,
Enhanced convenience with operators choice of reset methods,
Increased flexibility with operator or manual reset options for specific situational needs,
Maximum safety with easily identified input with fewer placement restrictions,
Low volume design approach with enabling wireless controllers,
Large volume design approach with discrete wireless devices.

All resistors are 5% unless stated otherwise. All capacitors are electrolytic unless stated otherwise.

Installation

The following steps will accomplish installation of my invention Safety Stop, all NEC and local code rules and procedures should be consulted prior to installation and followed.
1. Referring to FIG. 1 mount enclosure 102 near pump equipment and panel 124,
2. With power removed from load 125 disconnect associated power cables from panel 124,
3. Route supply power from panel 124 for main or number 1 motor to barrier 141 supply side connecting power supply line to connection 181, corresponding return line to connection 183, and ground line to open screw terminal on ground bar 142 (See FIG. 5 for barrier details).
4. Using 10 AWG solid core wire to make and install a jumper 182 from connection 181 to connection 185.
5. Using 10 AWG solid core wire to make and install a jumper 184 from connection 183 to connection 187
6. Supply power to main or number 1 motor by terminating power supply side wire connection 205 on barrier 141 on FIG. 5, also terminating return side wire at connection 207, and ground line should be terminated at an open screw terminal on bar 142 on FIG. 2.
7. Connect power to main or number 1 motor from enclosure 102 as directed by manufacturer and local codes
8. A second motor, pump, or heater should be connected in a similar manner, referring to FIG. 5 with power input at connection 189, also a returning line connection 191, and a ground line should be terminated at an open screw terminal on bar 142 on FIG. 2.
9. Supply power to a second motor, pump, or heater by terminating power supply side wire connection 201 on barrier 141 on FIG. 5, also terminating return side wire at connection 203, and ground line should be terminated at an open screw terminal on bar 142 on FIG. 2.
10. A third motor, pump, or heater should be connected in a similar manner, referring to FIG. 5 with power input at connection 193, also a returning line connection 195, and a ground line should be terminated at an open screw terminal on bar 142 on FIG. 2.
11. Supply power to a third motor, pump, or heater by terminating power supply side wire connection 197 on barrier 141 on FIG. 5, also terminating return side wire at connection 199, and ground line should be terminated at an open screw terminal on bar 142 on FIG. 2.
12. When power has passed inspection to NEC and local codes enable power from panel 124 press restart button 117 and start motors, pumps, or heaters (auto timer will start system equipment 125 connected in 15 minutes if restart switch 117 is not pressed).
13. Referring to FIG. 2, program transmitter 113 and receiver 128 and transmitter 108 and receiver 132 in pairs following manufacturer instructions.
14. Referring to FIG. 6A turn on switch 373 on transmitter 145 and assure LED 367 has illuminated.
15. Mount switch 101 to post or wall in open access to spa or pool.
16. Referring to FIG. 2 press switch 101 button to switch on enabling wireless controller and confirm that power through enclosure has been cutoff.
17. Referring to FIG. 6A position receiver 146 where it will be monitored and plug connector 374 into standard wall outlet (120V). Turn switch 376 until the alarm is audible through speaker 377 and display 375 visual indication can be observed
18. Referring to FIG. 2 press switch 108 button and confirm that power has restarted and alarm cutoff.
19. Close all cases and enclosures, system should operate without intervention except for checking batteries annually.
   Conclusions, Ramifications and Scope

Accordingly, the reader will see that the Safety Stop Device for Pools and Spas of this invention can be used to comply with NEC and improve safety for public usage. In addition the incorporation of common electrical parts and enclosures affords simple installation and low costs. Furthermore, the Safety Stop Device for Pools and Spas has the additional advantages in that.
a. provides a device to immediately halt operation of all pumps and heaters,
b. provides a reset that is separate from shut down switch to avoid misuse,
c. provides an electrically safe shut down of halt operation,
d. provides a positive halt to remove confusion or indecision,
e. provides a device that can be expanded to include multiple devices,
f. provides a device that can be easily installed, to provide a radio remote cutoff to simplify installation,
g. provides a radio remote reset to simplify system reset,
h. provides a radio remote alert to notify responsible individual,
i. provides a self contained auto reset function

Although the description above contains much specificity, these should not be construed as limiting the scope of the invention but as merely providing illustrations of some of the presently preferred embodiments of this invention. For example the device can service small application where only one or two loads are made safe by reducing relays. Larger demand applications can be accomplished with modular addition of enclosure 102 and circuitry, etc.

Thus the scope of the invention should be determined by the appended claims and their legal equivalents, rather than by the examples given.

What is claimed is:

1) An apparatus for orderly removal of power, during emergencies, from loads associated with control of commercial pools and spas, comprising;
means for receiving event input and transmitting event to information;
means for receiving event input information and removing signal power;
means for responding to removal of signal power with removal of power to loads;
means for wirelessly connecting event input means and signal means; and
means for resetting apparatus power.

2) An apparatus according to claim 1 wherein means for receiving event input is an electrical button switch.

3) An apparatus according to claim 1 wherein controller means receiving event input information is signal contactor coils.

4) An apparatus according to claim 1 wherein means for removal of signal power is signal contactor coils.

5) An apparatus according to claim 1 wherein means for responding to removal signal power is load contactor coils.

6) An apparatus according to claim 1 wherein means for removal of load power is load contactor coils.

7) An apparatus according to claim 1 wherein means for wirelessly connecting event input and signal means is a radio/transceiver pair.

8) An apparatus according to claim 1 wherein means for resetting power is separate from event input.

9) A radio/transceiver pair for control of commercial pools or spas loads during emergencies where signal coding is used for connectivity integrity.

10) A radio/transceiver pair of claim 9 wherein programming initializes pairs with unique identification.

11) A means for resetting power to controller of commercial pools or spas loads by operator direction following emergency input event.

12) A power resetting means according to claim 11 wherein an electrical switch performs reset.

13) A power resetting means according to claim 11 wherein a radio/transmitter pair performs reset in parallel-with switch.

14) A power resetting means according to claim 11 wherein a timer performs reset in parallel with switch

15) Means for, separately from controller of commercial pools or spas loads, remotely monitoring emergency input event.

16) Connectivity means according to claim 15 wherein a radio/transceiver pair connects controller and remote monitor means wirelessly.

17) Remote monitor means according to claim 15 wherein monitor generates an audible alert signal when apparatus receives event input.

18) Remote monitor means according to claim 15 wherein monitor audible alert signal is adjustable

19) Remote monitor means according to claim 15 wherein monitor generates a visual alert signal when apparatus receives event input.

20) Means for fulfilling input emergency event to controller of commercial pools or spas loads embodiment with enabling wireless controllers.

21) Means according to claim 20 wherein-embodiment is based on discreet wireless controllers.

22) Method of orderly removal of power from commercial pools and spas loads by emergency event input, comprising;
method for receiving event input and transmitting event to information;
method for receiving event input information and removing signal power;
method for responding to removal of signal power with removal of power to loads;
method for connecting event input method and signal means; and
method for resetting apparatus power.

23) A method according to claim 22 further comprising for receiving event input is an electrical button switch.

24) A method according to claim 22 further comprising receiving event input information is signal contactor coils.

25) A method according to claim 22 further comprising where removal of signal power initiated by reduced voltage at signal contactor coils.

26) A method according to claim 22 further comprising responding to removal signal power at load contactor coils.

27) A method according to claim 22 further comprising to removal of load power initiated by reduced voltage at load contactor coils.

28) A method according to claim 22 further comprising wirelessly connection event input and signal incorporating radio/transceiver pair.

29) A method according to claim 22 further comprising where resetting power is separate from event input.

30) A method of radio/transceiver pair control of commercial pools or spas loads during emergencies where signal coding is used for connectivity integrity.

31) A method of radio/transceiver pair connection of claim 30 wherein receiver programming uniquely identifies a transmitter on initialization.

32) A method for resetting controller of commercial pools or spas loads power, following an emergency event, by operator direction.

33) A power resetting method according to claim 32 wherein an electrical switch method is provided to perform controller reset.

34) A power resetting method according to claim 32 wherein a remote switch with a radio/transmitter pair reset method is provided in parallel with switch.

35) A power resetting method according to claim 32 wherein an operator selected timer reset method is provided in parallel with switch

36) Method of monitoring emergency input event to controller of commercial pools and spas separately from apparatus (remotely).

37) Connectivity method according to claim 36 further comprising a radio/transceiver pair connecting controller and remote monitor wirelessly.

38) Remote monitor method according to claim 36 further comprising monitor generating an audible alert signals when apparatus receives event input.

39) Remote monitor method according to claim 36 further comprising monitor adjustable audible alert signals.

40) Remote monitor method according to claim 36 further comprising monitor generating a visual alert signals when apparatus receives event input.

41) Method for fulfilling input emergency event to controller of commercial pools or spas loads embodiment with enabling wireless controllers.

42) Method according to claim-41 further comprising where embodiment is based on discreet wireless controllers.
